(19) United States
(12) Patent Application Publication
(10) Pub. No.: US 2015/0035833 A1
(43) Pub. Date: Feb. 5, 2015

(54) Visual Analytics of Temporal-spatial Relationships Using a Hierarchical Pixel Calendar Tree

(71) Applicant: Hewlett-Packard Development Company, L.P., Fort Collins, CO (US)

(72) Inventors: Ming C. Hao, Palo Alto, CA (US); Manish Marwah, Palo Alto, CA (US); Halldor Janetzko, Konstanz (DE); Meichun Hsu, Los Altos Hills, CA (US); Umeshwar Dayal, Saratoga, CA (US); Daniel Keim, Steisslingen (DE)

(73) Assignee: Hewlett-Packard Development Company, L.P., Fort Collins, CO (US)

(21) Appl. No.: 13/955,961

(22) Filed: Jul. 31, 2013

(51) Int. Cl. G06T 11/20

(52) U.S. Cl. CPC G06T 11/206
USPC 345/440

(57) ABSTRACT

Example embodiments relate to providing visual analytics of temporal-spatial relationships. In example embodiments, power meters may be located at regions within a building for collecting power consumption data at regular intervals. The power consumption data can be recursively processed to generate a pixel calendar tree by using a power meter hierarchy to subdivide the pixel calendar tree into tree portions according to a proportion of the power consumption data attributed to each of power meter nodes, where the tree portions are arranged in the pixel calendar tree according to an importance of the proportion; generating pixel cells in the pixel calendar tree that each represent a day in the power consumption data; and generating cell borders that each surround one of the pixel cells. At this stage, a pixel calendar display of a physical infrastructure of the building that includes the pixel cells and the cell borders can be generated.

### BACKGROUND

Modern commercial buildings include complex systems of sensors that collect various types of data (e.g., energy consumption data, temperature data, carbon monoxide levels, water cooling data, etc.). For example, a commercial building may include power meters that monitor power consumption in different regions of the building. The consumption data obtained by the power meters may be used to determine power usage patterns and anomalies in the building in order to optimize power savings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following detailed description references the drawings, wherein:

FIG. 1 is a block diagram of an example computing device for providing visual analytics of temporal-spatial relationships using a pixel calendar tree;

FIG. 2 is a block diagram of an example computing device in communication with sensors for providing visual analytics of temporal-spatial relationships using a pixel calendar tree;

FIG. 3A is a flowchart of an example method for execution by a computing device for providing visual analytics of a pixel calendar tree with cell borders;

FIG. 3B is a flowchart of an example method for execution by a computing device for providing visual analytics of temporal-spatial relationships using a pixel calendar tree;

FIG. 4 is a flowchart of an example method for execution by a computing device for providing visual analytics of temporal-spatial relationships using a pixel calendar tree with cell borders;

FIG. 5A is a color diagram of an example pixel calendar tree of power consumption data collected from a number of buildings;

FIG. 5B is a color diagram of the example pixel calendar tree of FIG. 5A with cell borders;

FIGS. 6A-6B are color diagrams of example pixel calendar trees of power consumption data that show visual similarity relationships; and

FIGS. 7A-7B are color diagrams of example pixel calendar trees of power consumption data that show visual correlation relationships.

### DETAILED DESCRIPTION

As detailed above, modern commercial buildings include complex networks or sensors for capturing various types of data. In many cases, the sensor data is analyzed to identify anomalies so that adjustments may be made to the building's configuration. For example, consumption data from power meters may be used to identify a particular region within a commercial building that is consuming a disproportionate amount of power. However, it is difficult to provide visualization tools that can simultaneously display and analyze measurements collected from all of the sensors (e.g., power meters) in a commercial building. Administrators of the commercial building are unable to simultaneously exploit sensor time series data from all sensors for identifying issues and inferring the root causes of anomalies.

Example embodiments disclosed herein provide visual analytics of temporal-spatial relationships using a pixel calendar tree. For example, in some embodiments, power meters may be located at regions within a building for collecting power consumption data at regular time intervals. The power consumption data can be recursively processed to generate a pixel calendar tree by using a power meter hierarchy to subdivide the pixel calendar tree into tree portions according to a proportion of the power consumption data attributed to each of power meter nodes, where the tree portions are arranged in the pixel calendar tree according to an importance of the proportion; generating pixel cells in the pixel calendar tree, where each of the pixel cells represents a day in the power consumption data; and generating cell borders that each surround one of the pixel cells. At this stage, a pixel calendar display including the pixel cells and the cell borders can be generated.

In this manner, example embodiments disclosed herein provided improved visualization of temporal-spatial relationships in time series data by using a pixel calendar tree to perform visual queries. Specifically, by using a pixel calendar tree, similarities or correlations may be quickly identified in time series sensor data and then simultaneously displayed for analysis.

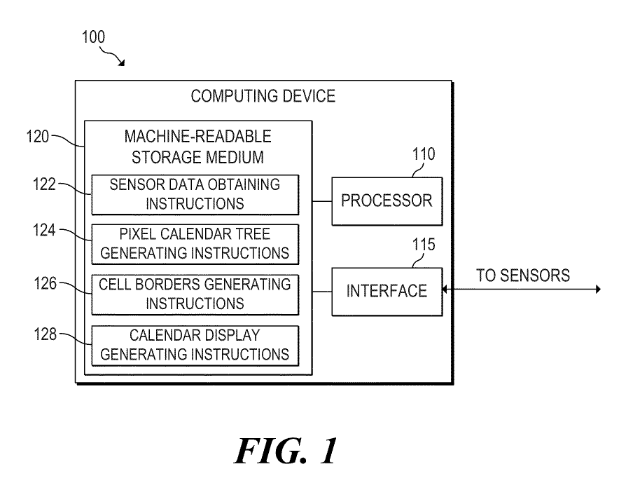

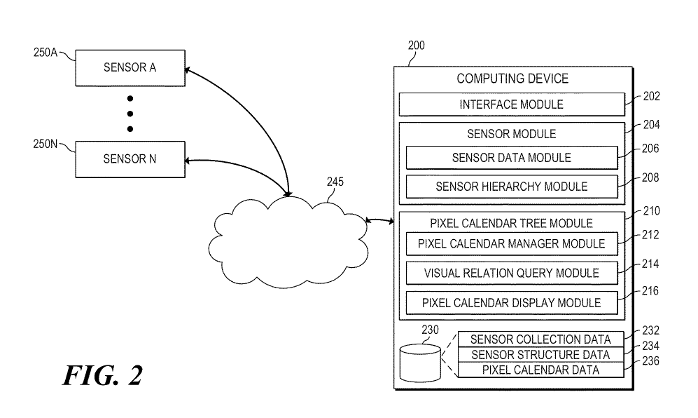

Referring now to the drawings, FIG. 1 is a block diagram of an example computing device 100 for providing visual analytics of temporal-spatial relationships using a pixel calendar tree. Computing device 100 may be any computing device (e.g., smartphone, tablet, laptop computer, desktop computer, etc.) capable of accessing sensor data that is obtained from sensors in a building, such as sensor A 250A and sensor N 250N of FIG. 2. In the embodiment of FIG. 1, computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable visual analytics of temporal-spatial relationships using a pixel calendar tree, as described below. As an alternative or in addition to retrieving and executing instructions, processor 110 may include one or more electronic circuits comprising a number of electronic components for performing the functionality of one or more of instructions 122, 124, 126, 128.

Interface 115 may include a number of electronic components for communicating with sensors. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the sensors. Alternatively, interface 115 may be a wireless interface, such as a wireless local area network (WLAN) interface or a near-field communication (NFC) interface. In operation, as detailed below, interface 115 may be used to send and receive data, such as sensor data, to and from a corresponding interface of sensors.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for providing visual analytics of temporal-spatial relationships using a pixel calendar tree.

Sensor data obtaining instructions 122 may receive sensor data from sensors installed in a building. For example, power consumption data may be received from power meters installed at various locations in a building. Each of the sensors may be associated with a region (e.g., room, hallway, floor, wing, etc.) of the physical infrastructure of the building and arranged in a sensor hierarchy as discussed above. In some cases, sensor data obtaining instructions 122 may receive the sensor data at regular intervals in real-time. Alternatively, the sensors may store sensor data collected at regular intervals and transmit the sensor data on a less regular basis (e.g., daily, weekly, monthly, etc.). Sensor data may be collected by various types of sensors such as power meters, thermometers, light sensors, etc.

Pixel calendar tree generating instructions 124 may generate a pixel calendar tree based on a sensor hierarchy and the sensor data. The sensor hierarchy may reflect the child-parent relationships between sensors within the building. For example, the sensor hierarchy may show the parent-child relationship between power meters and distribution boards of a building, where a main distribution board is the root node of the sensor hierarchy. The pixel calendar tree may be divided into rectangles that are each associated with a sensor in the building, where the rectangles represent the location of the associated sensor within the sensor hierarchy. In this case, the size of each of the rectangles is proportional to a portion of sensor data that is attributable to the associated sensor. For example, a power meter reporting higher power consumption is displayed as a larger rectangle in the pixel calendar tree that is proportional to the associated region's percentage of power consumption in the entire building.

Pixel calendar tree generating instructions 124 may also include time series sensor data in each of the rectangles to represent the sensor data collected during each of the regular intervals by the sensors. For example, the sensors may collect sensor data every five minutes, and the time series sensor data may include a data entry for data collected during each of the data intervals. The time series sensor data may be included in the pixel calendar tree as pixel cells, where each pixel cell represents sensor data for a time interval (e.g., hour, day, week, etc.).

Cell borders generating instructions 126 may generate cell borders for the pixel calendar tree. Specifically, the time series data in each of the pixel calendar trees may be processed so that a cell border is created around each pixel cell in the pixel calendar tree, where a pixel cell represents, for example, power consumption data of a single day. Further, the cell borders may be nested and have different widths so that different time intervals can be distinguished in the pixel calendar tree. For example, cell borders may be generated for days, which are grouped together in thicker cell borders for weeks, which in turn are grouped together in even thicker cell borders for months, and so on. Cell borders may also be generated for time intervals smaller than a day (e.g., minute(s), hour(s), etc.). In some case, the cell borders may be generated as the pixel cells are recursively generated based on the sensor data. In this case, the cell borders may be generated as empty space between the pixel cells that increase the readability of the time series sensor data.

Calendar display generating instructions 128 may render the pixel calendar tree for displaying. For example, rectangles for each of the sensors may be resited and fitted such that children nodes fit into the rectangle of their parent node (i.e., rectangles for sensors installed in rooms cleanly fit into the parent rectangle for a distribution board of a floor in the building). In this example, rectangles may be arranged within their parent rectangles based on their relative size to each other (e.g., largest rectangle in the upper left to smallest rectangle in the lower right). The relative size of the rectangles may be proportional to the sensor data attributable to each of the sensors. Within the rectangles, the pixel cells and cell borders are rendered so that each pixel cell can be easily distinguished from its neighboring pixel cells because of the cell borders.

FIG. 2 is a block diagram of an example computing device 200 in communication via a network 245 with sensors (e.g., sensor A 250A, sensor N 250N). As illustrated in FIG. 2 and described below, computing device 200 may communicate with sensors to provide visual analytics of temporal-spatial relationships using a pixel calendar tree.

As illustrated, computing device 200 may include a number of modules 202-216. Each of the modules may include a series of instructions encoded on a machine-readable storage medium and executable by a processor of the computing device 200. In addition or as an alternative, each module may include one or more hardware devices including electronic circuitry for implementing the functionality described below.

As with computing device 100 of FIG. 1, computing device 200 may be a notebook, desktop, tablet, workstation, mobile device, or any other device suitable for executing the functionality described below. As detailed below, computing device 200 may include a series of modules 202-216 for providing visual analytics of temporal-spatial relationships using a pixel calendar tree.

Interface module 202 may manage communications with the sensors (e.g., sensor A 250A, sensor N 250N). Specifically, the interface module 202 may initiate connections with the sensors and receive sensor collection data 232 from the sensors.

Sensor module 204 may manage sensor data obtained from the sensors (e.g., sensor A 250A, sensor N 250N) and other sources. Although the components of sensor module 204 are described in detail below, additional details regarding an example implementation of module 204 are provided above in connection with instructions 122 of FIG. 1.

Sensor data module 206 may process sensor data received from the sensors (e.g., sensor A 250A, sensor N 250N). The sensor data may include measurements (e.g., power consumption, temperature, etc.) collected by the sensors (e.g., sensor A 250A, sensor N 250N) at regular intervals. The sensor data may also include an identifier (e.g., numeric identifier, alpha-numeric identifier, globally unique identifier, etc.) that is associated with the related sensor (e.g., sensor A 250A, sensor N 250N) providing the sensor data. In this manner, sensor data module 206 may continually receive sensor data from the sensors (e.g., sensor A 250A, sensor N 250N) and compile the sensor data into time series sensor data that is stored as sensor collection data 232 in storage device 230. The time series sensor data may include data records for the measurements taken during each interval so that the time series sensor data may be incorporated into a pixel calendar.

Sensor data module 206 may also generate summary information for each of the sensors (e.g., sensor A 250A, sensor N 250N) based on the sensor data. For example, sensor data module 206 may determine the cumulative power consumption of a power meter over an extended period of time (e.g., a day, a week, a month, etc.). The summary information may be linked to an identifier associated with the power meter in the sensor collection data 232 of storage device 230 so that the summary information may be used by the pixel calendar tree module 210.

Sensor hierarchy module 208 may generate a sensor hierarchy based on the physical infrastructure of a building that includes sensors (e.g., sensor A 250A, sensor N 250N). A sensor hierarchy may reflect the layout and connections between sensors (e.g., sensor A 250A, sensor N 250N) in a building. For example, a sensor hierarchy for power meters may reflect the parent-child relationship between distribution boards and power meters installed in a building. The physical infrastructure of a building for building a sensor hierarchy may be determined based on digital plans of the building and/or inputs from an administrator of computing device 200. For example, sensor hierarchy module 208 may provide a user interface for specifying a sensor hierarchy for sensors (e.g., sensor A 250A, sensor N 250N) connected to computing device 200. The connected sensors (e.g., sensor A 250A, sensor N 250N) may provide some information related to the physical infrastructure of buildings such as building identifiers, floor identifiers, etc. In this case, the user interface may group connected sensors based on their building or floor and allow the administrator to specify the sensor hierarchy of the connected sensors. Sensor hierarchies may be stored as sensor structure data 234 in storage device 230.

Pixel calendar tree module 210 may manage pixel calendar trees that are generated based on sensor data processed by the sensor module 204. Although the components of pixel calendar tree module 210 are described in detail below, additional details regarding an example implementation of module 210 are provided above in connection with instructions 124, 126, and 128 of FIG. 1.

Pixel calendar manager module 212 may generate pixel calendar trees based on sensor hierarchies and sensor data. Specifically, a pixel calendar tree may initially be generated using a sensor hierarchy and sensor summary information. The sensor hierarchy may be used to determine how nested rectangles representing the sensors should be arranged within the pixel calendar tree (i.e., rectangles for child sensors being displayed within their respective parent sensor's rectangle). Further, the sensor summary information may be used to determine the dimension of the sensor rectangles within the pixel calendar tree. For example, rectangles for power meters may be generated to be proportional to the cumulative power consumption of the power meters during a global time period (i.e., time period that includes all time intervals of the sensor data) of the pixel calendar tree. In this example, the aspect ratio of the rectangles may be recursively adjusted to find the best fit for all rectangles in the pixel calendar tree. The best fit algorithm may be applied from the top to the bottom of the sensor hierarchy such that the best fit for a level of parent nodes is determined before the best fit of each of their child nodes is determined and so on.

Pixel calendar manager module 212 may also process time series sensor data from sensor module 204 so that the time series sensor data may be included in a pixel calendar tree. Specifically, the time series sensor data may be associated with the pixel calendar tree so that each sensor rectangle includes the time series sensor data from the corresponding sensor. A rendering style may be generated for the time series sensor data based on a range of data values in the sensor data and the size of the sensor rectangles. For example, a color map may be generated to represent the range of data values in a pixel calendar. In this example, the amount of data represented in each pixel may be determined based on the size of a sensor rectangle. A smaller sensor rectangle may include more time intervals of sensor data in each pixel to allow for the entirety of the time series sensor data to be simultaneously displayed. In this case, the rendering style may be configured to render the time intervals separately if the user zooms into the sensor rectangle.

Visual relation query module 214 may perform visual relation queries using pixel calendar trees to identify related portions of the pixel calendar tree. Specifically, a visual relation query may use an interested area selected by the user to search for similar or correlated portions of the pixel calendar tree. A portion of the pixel calendar tree may be similar if it describes a measured property from the sensor data that is approximately equal to the measured property in the interested area. For example, if the sensors are power meters, the similar portions of the area of interest may have approximately the same amount of power consumption as the interested area. A portion of the pixel calendar tree may correlate to the interested area if both include a similar pattern of a measured property. For example, if the sensors are power meters, the correlated portions of the area of interest may have approximately the same pattern of power consumption (i.e., increasing and decreasing at approximately the same time intervals) as the interested area. For correlation queries, the overall quantity of the measured property is not considered.

For example, a visual similarity query may be performed by applying a weighted Euclidian Distance comparison over time, where the latest time intervals are weighted more than the previous time intervals. In the case of power consumption data, the power consumption values in the interested area may be compared to power consumption values for other power meters during the same time period as the interested area, where each of the comparisons are then aggregated to calculate an overall comparison. Another power meter is identified as being similar to the interested area if the overall comparison of the power consumption values is similar as shown by the aggregated Euclidian distance between the power consumption values is minimized.

In another example, a visual correlation query may be performed by applying a Pearson correlation computation to compare changes in values (e.g., positive change, negative change, unsigned). In the case of power consumption data, the pattern of usage of power consumption in the interested area is used to identify other power meters that have a similar pattern of usage during the same time period.

Pixel calendar display module 216 may render pixel calendar trees for display on a display device (not shown) of computing device 200. The display of the pixel calendar tree may allow the user to select areas of interest in the displayed tree. For example, user interface elements may be provided along with a display of the pixel calendar tree, where the user interface elements allow the user to select a period of time (e.g., hours, days, weeks, etc.) in the pixel calendar tree as the interested area. Pixel calendar display module 216 may also allow the user to specify parameters for a requested visual relation query for the selected area of interest.

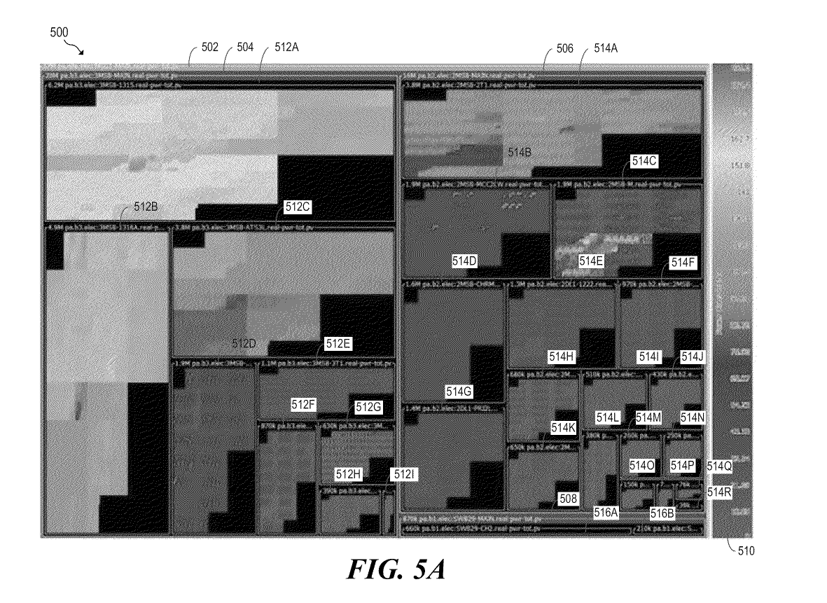

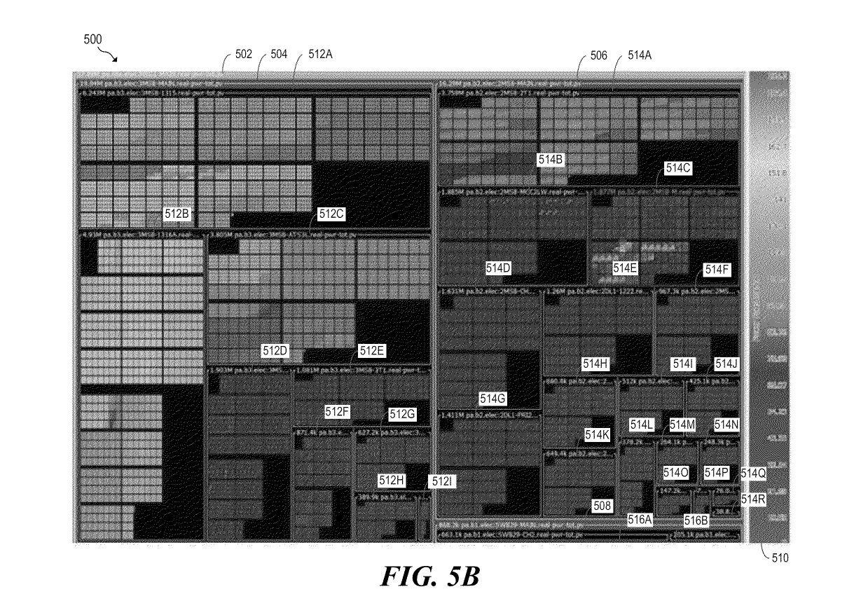

Time series sensor data may be rendered as pixels within the rectangles, where each pixel represents sensor data collected during a time interval by the associated sensor. Further, each pixel may be color coded based on the value of the sensor data. For example, high power consumption during a time interval may be rendered as a red pixel while low power consumption during a time interval may be rendered as a violet pixel. Examples of rendered pixel calendar trees are described below with respect to FIGS. 5A-5B.

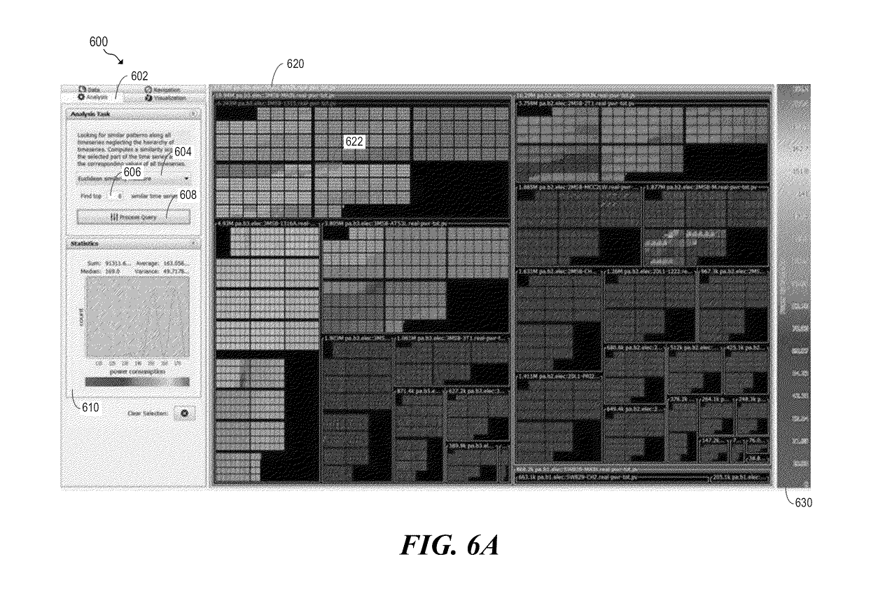

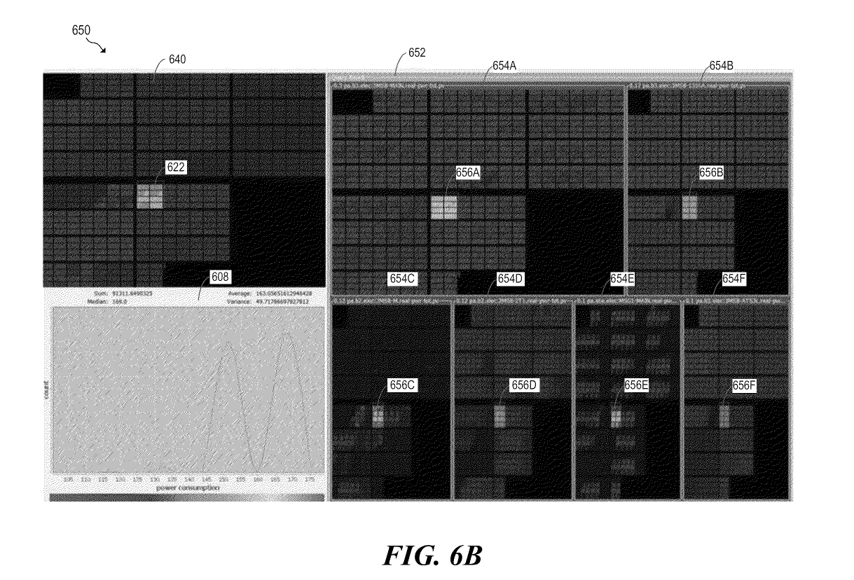

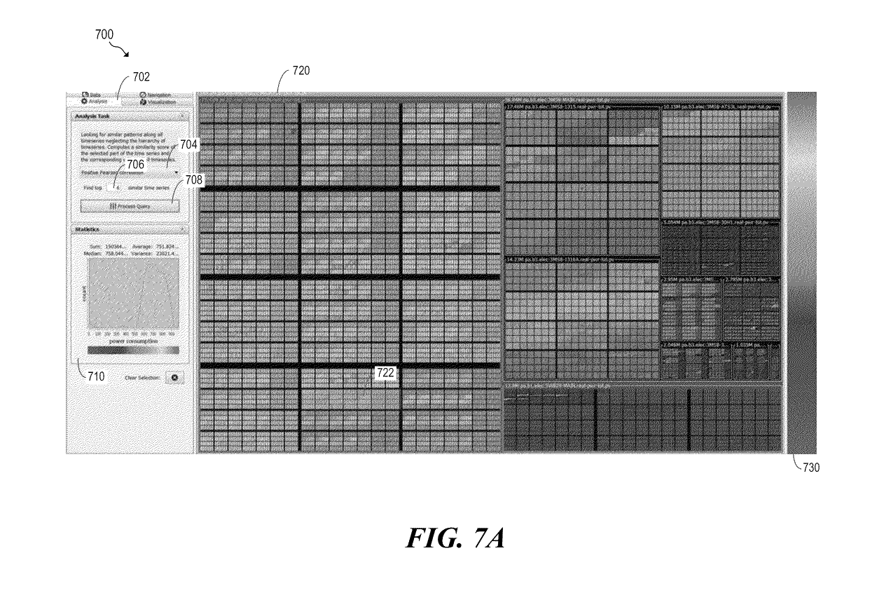

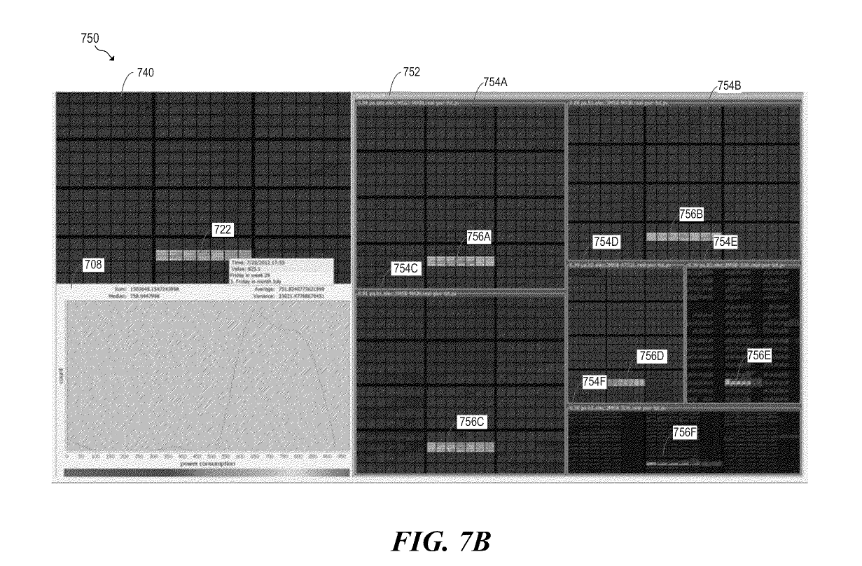

Pixel calendar display module 216 may also render temporal-spatial relationships for display on a display device (not shown) of computing device 200. For example, temporal-spatial relationships may be rendered for display as described below with respect to FIGS. 6A-6B and 7A-7B. The temporal-spatial relationships may be rendered such the relation portions of a pixel calendar tree are highlighted within a sensor rectangle showing time series data of an associated sensor. Further, the sensor rectangles of the related portions may be arranged according to the relative size of each of the sensor rectangle with respect to the other related sensor rectangles. In this way, the temporal-spatial relationships from multiple sensors in the sensor hierarchy may be simultaneously displayed for review by a user. The rendered temporal-spatial relationships may be stored as pixel calendar data 236 in storage device 230.

Specifically, temporal-spatial relations may be rendered in a unified display that includes the interested area and the related portions of the pixel calendar tree for displaying. For example, the pixel calendar tree may be rendered so that the interested area is brightened and the remaining area is de-emphasized by fading it out. In this example, each of the related portions may be rendered to be simultaneously displayed with the pixel calendar tree. A related portion may be rendered within a visualization of sensor data attributable to a single sensor. In the unified display, rectangles for each of the sensors may be resited and fitted such that children nodes fit into the rectangle of their parent node i.e., rectangles for sensors installed in rooms cleanly fit into the parent rectangle for a distribution board of a floor in the building). In this example, rectangles may be arranged within their parent rectangles based on their relative size to each other (e.g., largest rectangle in the upper left to smallest rectangle in the lower right). The relative size of the rectangles may be proportional to the sensor data attributable to each of the sensors.

For example, if the sensor data is power consumption data, the relative size of the rectangles may be determined based on the power consumption that is attributable to each of the corresponding power meters in the building. In this example, the power consumption data may also be used to data measurements, where the scale describes the range of data values from the minimum measured value to the maximum measured value in the power consumption data. The scale may then be used to determine the relative size of the power meter rectangles based on the power consumption data attributable to each of the power meters.

The rendered unified display allows a user to simultaneously view time series sensor data for multiple buildings along with portions of the pixel calendar tree that are related to the interested area on a single display.

Storage device 230 may be any hardware storage device for maintaining data accessible to computing device 200. For example, storage device 230 may include one or more hard disk drives, solid state drives, tape drives, and/or any other storage devices. The storage devices 230 may be located in computing device 200 and/or in another device in communication with computing device 200. As detailed above, storage device 230 may maintain sensor collection data 232, sensor structure data 234, and pixel calendar data 236.

Sensors (e.g., sensor A 250A, sensor N 250N) may be any sensor device operatively connected to computing device 200 over the network 245 that is suitable for collecting measurements of characteristics (e.g., power consumption, temperature, etc.) related to a building. Sensors (e.g., sensor A 250A, sensor N 250N) may provide sensor data that includes measurements collected at regular intervals.

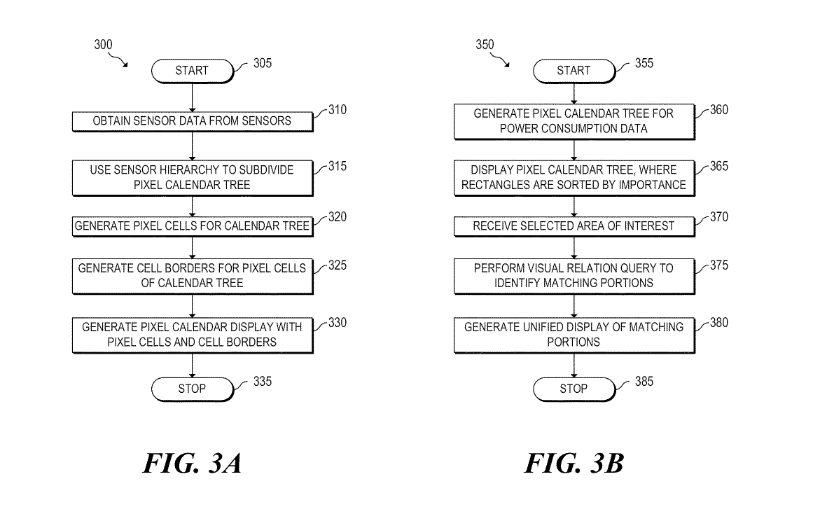

FIG. 3A is a flowchart of an example method 300 for execution by a computing device 100 for providing visual analytics of a pixel calendar tree with cell borders. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 may obtain sensor data from sensors in a building. The sensor data may include measurements collected by the sensors at regular intervals. In block 315, a sensor hierarchy is used to subdivide the sensor data into portions for the pixel calendar tree. Specifically, the sensor hierarchy may be used to initially determine the layout of sensor rectangles in the pixel calendar tree. At this stage, the sensor data may be used to determine the relative size and aspect ratios of the sensor rectangles within the pixel calendar tree. For example, each sensor rectangle may be proportionally sized according to the total power consumption measured by a corresponding sensor. Further, the sensor rectangles may be arranged according to the relative importance of each of the sensor rectangle with respect to their sibling rectangles (i.e., rectangles sharing a common parent in the sensor hierarchy).

In block 320, pixel cells are generated for the pixel calendar tree. Specifically, time series sensor data (i.e., the measurements collected at regular intervals) may be associated with each of the sensor rectangles. In this case, each pixel cell represents a time interval (e.g., hour, day, week, etc.) within the time series sensor data. In block 325, cell borders are generated for the pixel cells of the pixel calendar tree. Specifically, the time series data in the pixel calendar tree may be processed so that a cell border is created around each pixel cell in the pixel calendar trees, where a pixel cell represents sensor data of, for example, a single day.

In block 330, the pixel calendar display is generated with the pixel cells and the cell borders. For example, the pixel calendar tree may be displayed as described below with respect to FIG. 5B. In this example, the time series sensor data is shown as a pixel calendar within each of the sensor rectangles, where each of the sensor rectangles includes pixels cells that are easily distinguishable because of the cell borders. Method 300 may then continue to block 335, where method 300 may stop.

FIG. 3B is a flowchart of an example method 350 for execution by a computing device 100 for providing visual analytics of temporal-spatial relationships using a pixel calendar tree. Although execution of method 350 is described below with reference to computing device 100 of FIG. 1, other suitable devices for execution of method 350 may be used, such as computing device 200 of FIG. 2. Method 350 may be implemented in the form of executable instructions stored on a machine-readable storage medium, such as storage medium 120, and/or in the form of electronic circuitry.

Method 350 may start in block 355 and continue to block 360, where computing device 100 may generate a pixel calendar tree based on sensor data and a sensor hierarchy. The sensor hierarchy may be used to initially determine the layout of sensor rectangles in the pixel calendar tree. At this stage, the sensor data may be used to determine the relative size and aspect ratios of the sensor rectangles within the pixel calendar tree. For example, each sensor rectangle may be proportionally sized according to the total power consumption measured by a corresponding sensor. Further, the sensor rectangles may be arranged according to the relative size of each of the sensor rectangle with respect to their sibling rectangles (i.e., rectangles sharing a common parent in the sensor hierarchy). Finally, time series sensor data (i.e., the measurements collected at regular intervals) may be associated with each of the sensor rectangles.

In block 365, the pixel calendar tree is displayed, where the sensor rectangles are arranged by importance according to their relative size as discussed above. Time series sensor data may be shown as pixel cells within each of the sensor rectangles of the pixel calendar tree. In block 370, a selected area of interest is received by computing device 100. The area of interest may be selected by a user in the display of the pixel calendar tree generated in block 365. For example, the user may use user interface elements in the display to select a period of time for sensor data associated with a sensor included in the pixel calendar tree. In some cases, the area of interest may be received as part as a visual relation search request, which also includes search parameters for performing a visual relation query.

In block 375, computing device 100 performs the visual relation query to identify matching portions of the pixel calendar tree. The visual relation query may identify portions that are similar or correlate to the area of interest. For example, a visual similarity query may be performed to identify similar portions that have an overall power consumption that is similar to the area of interest. Example pseudo-code for performing a visual similarity query is found below in TABLE 1.

TABLE 1
pseudo-code for visual similarity query

public static double getSimilarity(double[ ] values1, double[ ] values2) {

double result = 0;
switch (Config.getInstance( ).getSimilarity( )) {
case EUCLIDEAN_DISTANCE:

result = getEuclideanDistance(values1, values2) + 0.0000001;
result = 1 / result;
break;

default:

result = NumericStatistics.getCorrelation(values1, values2);
break;

}
if (Double.isNaN(result)) {
result = 0;
}
return result;

```
  }
  public static double getEuclideanDistance(double[ ] values1, double[ ]
  values2) {
```

```
double result = 0;
if (values1.length l = values2.length) {
  throw new IllegalArgumentException(“Array length must be
  equal”);
}
for (int i = 0; i < values1.length; i++) {
  result += (Math.pow(values1[i] − values2[i], 2));
}
return Math.sqrt(result);
```

}

As shown in TABLE 1, the visual similarity query includes comparing Euclidean distances between values (e.g., power consumption values) in the sensor data. In this example, the getSimilarity method returns a value describing the similarity of the two sets of values. To perform the visual similarity query, computing device 100 may compare the values from the area of interest to corresponding values in each of the other sensors that occur during the same period of time as the area of interest. If the result of getSimilarity satisfies a preconfigured threshold, the other sensor being compared may be identified as a matching portion of the calendar tree.

In another example, a visual correlation query may be performed to identify correlated portions that have a value pattern (e.g., power consumption usage pattern) that is similar to the area of interest. The following is an example Pearson correlation equation for performing a visual correlation query:

$$r = \frac{{\sum }_{i = 1}^{n} ( {A}_{1 i} - {\overline{A}}_{1} ) ( {A}_{2 i} - {\overline{A}}_{2} )}{\sqrt{{\sum }_{i = 1}^{n} {( {A}_{1 i} - {\overline{A}}_{1} )}^{2} {\sum }_{i = 1}^{n} {( {A}_{2 i} - {\overline{A}}_{2} )}^{2}}} ,$$

With n points, Pearson's r may be a value between −1 and 1. The sign of r identifies the direction of the relationship while the magnitude of r identifies the strength of the linear relationship. The magnitude of r increases if the values being compared have the same change in pace and, thus, a similar pattern.

In block 380, computing device 100 generates a unified display that includes the matching portions identified in block 375. For example, the matching portions may be displayed as described below with respect to FIG. 6A-6B or 7A-7B. In this example, each of the matching portions is included in time series sensor data for a corresponding sensor rectangle, which allows a user to simultaneously view matching portions from multiple sensors in the building. The unified display allows the user to quickly identify other regions of the building that have similar or related characteristics (e.g., power consumption) as the area of interest. For example, a user may quickly identify all the regions in the building that have high energy consumption during the selected period of time, which may assist the user in identifying the root cause of the high energy consumption. Method 350 may then continue to block 385, where method 350 may stop.

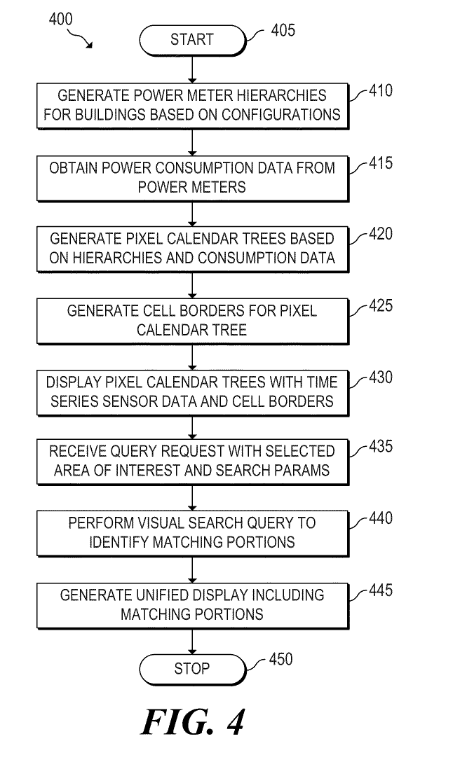

FIG. 4 is a flowchart of an example method 400 for execution by a computing device 200 for providing visual analytics of temporal-spatial relationships using a pixel calendar tree with cell borders. Although execution of method 400 is described below with reference to computing device 200 of FIG. 2, other suitable devices for execution of method 400 may be used, such as computing device 100 of FIG. 1. Method 400 may be implemented in the form of executable instructions stored on a machine-readable storage medium and/or in the form of electronic circuitry.

Method 400 may start in block 405 and continue to block 410, where computing device 200 creates a power meter hierarchy for each of the buildings using a corresponding sensor configuration. The sensor configurations may be digital building plans and/or user inputs from an administrator of computing device 200. A sensor configuration may describe the location and configuration of power meters within the physical infrastructure of a building.

In block 415, power consumption data is obtained from power meters in the building. For example, the power meters may collect power consumption data at regular intervals for transmitting to the computing device 200. In block 420, computing device 200 generates pixel calendar trees based on the power meter hierarchies and the power consumption data. In block 425, cell borders are generated for the pixel calendar trees. Specifically, the time series data in each of the pixel calendar trees may be processed so that a cell border is created around each pixel cell in the pixel calendar trees, where a pixel cell represents power consumption data of a single day. TABLE 2 below shows example pseudo-code for generating cell borders for a pixel calendar tree.

TABLE 2
pseudo-code for generating cell borders

| 1 | if level == −1 then | |
|---|---|---|
| 2 | \| | SetPixel(x, y, color); |

| | | |
|---|---|---|
| 3 | else | // level >= 0 |

| 4 | \| | next_x = πᵢ₊₀^{level-1} widths[i]; | | |
|---|---|---|---|---|
| 5 | \| | next_y = πᵢ₊₀^{level-1} heights[i]; | | |
| 6 | \| | next_border_x = 0; | | |
| 7 | \| | for i = 0; i < level; i++ do | | |
| 8 | \| | \| | next_border_x = next_border_x * widths[i] + (widths[i] − 1) * xBorders[i]; | |
| 9 | \| | end | | |
| 10 | \| | next_border_y = 0; | | |
| 11 | \| | for i = 0; i < level; i++ do | | |
| 12 | \| | \| | next_border_y = next_border_y * heights[i] + (heights[i] − 1) * yBorders[i]; | |
| 13 | \| | end | | |
| 14 | \| | for h = 1; h <= heights[level]; h++ do | | |
| 15 | \| | \| | if level == −1 then | // odd row |

| | | | | |
|---|---|---|---|---|
| 16 | \| | \| | \| | for int w = 1; w <= widths[level]; w++ do |
| | \| | \| | \| | \| // recursive call of the algorithm |
| 17 | \| | \| | \| | \| drawRecursivePattern(x, y, level − 1); |
| 18 | \| | \| | \| | \| x += next_x + next_border_x + xBorders[level]; |
| 19 | \| | \| | \| | end |

| | | | | |
|---|---|---|---|---|
| 20 | \| | \| | end | // even row |

| | | | | |
|---|---|---|---|---|
| 21 | \| | \| | \| | for int w = 1; w <= widths[level]; w++ do |
| 22 | \| | \| | \| | \| x −= next_x + next_border_x + xBorders[level]; |
| | \| | \| | \| | \| // recursive call of the algorithm |
| 23 | \| | \| | \| | \| drawRecursivePattern(x, y, level − 1); |
| 24 | \| | \| | \| | end |

| | | | |
|---|---|---|---|
| 25 | \| | \| | end |
| 26 | \| | \| | y += next_y + next_border_y + yBorders[level]; |

| | | |
|---|---|---|
| 27 | \| | end |

| | |
|---|---|
| 28 | end |

In TABLE 2, a power meter rectangle is recursively processed to draw cell borders based on the width and the height of the power consumption rectangle. Cell borders are rendered in the power meter rectangle empty pixels between the pixel cells representing sensor data. Specifically, lines 6-13 in TABLE 2 calculate the amount of empty space both horizontally and vertically that should occur between the pixel cells, and lines 18 and 26 displace the current horizontal and vertical position being processed to create the empty pixels (e.g., black pixels) between the pixel cells as the cells are recursively rendered.

In block 430, computing device displays the pixel calendar trees of the buildings with time series sensor data. The pixel calendar trees of the buildings may be arranged according to the total sensor data attributable to each of the buildings. Further, similar to the power meter rectangles, the aspect ratios of the pixel calendar trees for the buildings may be adjusted to find the best fit in a combined pixel calendar tree. The display of the combined pixel calendar tree allows the user to view the time series sensor data of all the buildings and all their sensors on a single display.

In block 435, a visual relation query request is received that includes a selected area of interest and search parameters. Example search parameters may include the type of search (i.e., visual similarity search or visual correlation search) and a number of results that should be returned from the search (e.g., the six closest results). In block 440, computing device 200 performs the visual relation query to identify matching portions of the pixel calendar tree. The visual relation query may identify portions that are similar or correlate to the area of interest.

In block 445, computing device 200 generates a unified display that includes the matching portions identified in block 400. For example, the matching portions may be displayed as described below with respect to FIG. 6A-6B or 7A-7B. In this example, each of the matching portions is included in time series sensor data for a corresponding power meter rectangle, which allows a user to simultaneously view matching portions from multiple sensors in all of the building. Method 400 may then continue to block 450, where method 400 may stop.

FIGS. 5A-5B are color diagrams of example pixel calendar trees including time series consumption data for a number of buildings. In FIG. 5A, pixel calendar tree 500 includes a main meter rectangle 502 that represents a main distribution board installed in the building. The main sensor rectangle 502 includes three intermediate meter rectangles 504, 506, 508 that represent intermediate distribution boards installed in the building. As discussed above, the size of each of the intermediate meter rectangles 504, 506, 508 is proportional to the amount of consumption data that is attributable to their corresponding intermediate distribution board.

In this case, intermediate meter rectangle 504 shows the greatest power consumption and includes power meter rectangles 512A-512I. The size of each of the power meter rectangles 512A-512I is proportional to the amount of consumption data that is attributable to their corresponding power meter. Further, each of the power meter rectangles 512A-512I includes a pixel calendar that displays time series consumption data. Specifically, each pixel in the power meter rectangles 512A-512I represents the amount of power consumption occurring each day according to the consumption color map 510 for representing the scale of the power consumption data displayed. In this consumption color map 510, violet signifies low power consumption while red signifies high power consumption. Each of the other intermediate meter rectangles 506, 508 similarly includes corresponding power meter rectangles 514A-514R, 516A-516B.

FIG. 5B shows the pixel calendar tree of FIG. 5A with cell borders. The cell borders allow a user to quickly differentiate time periods within the pixel calendar tree. For example, the time series data of power meter rectangle 512A is grouped such that each month of time series data can be easily distinguished, where within each month the user can further distinguish each week of time series data, and where within each week the user can further distinguish each day of time series data. The cell borders allow the user to visually select an area of interest for performing visual relation queries.

FIGS. 6A-6B are color diagrams of example pixel calendar trees of power consumption data that show visual similarity relationships. In FIG. 6A, pixel calendar tree display 600 includes a pixel calendar tree 620 that presents consumption data for the building. Pixel calendar tree display 600 also includes user interface elements 602 for specifying visual search query parameters. Specifically, user interface elements 602 include a search type drop down 604 for specifying whether the visual relation query should be a visual similarity query or a visual correlation query, a results quantity textbox 606 for specifying the number of results that should be returned from the query, and a process query button 608 for submitting the request for the query. In this example, the search type drop down 604 shows that a visual similarity query is selected.

Pixel calendar tree display 600 also includes a histogram 610 showing statistics for the currently selected area of interest 622. The user may specify the selected area of interest 622 by, for example, dragging a selection box over the desired portion of the pixel calendar tree 620.

FIG. 6B shows the results of a visual relation query as rendered in a unified display 650. A portion 640 of the pixel calendar tree 620 of FIG. 6A is displayed to show the selected area of interest 622. In this example, the histogram 610 showing statistics for the selected area of interest is rendered just below the pixel calendar tree 620 in the unified display 610. The unified display 650 also includes query results 652, which in turn includes similar portions 654A-654F of the pixel calendar tree 620 of FIG. 6A. Each of the similar portions 654A-654F displays a subset of the pixel calendar tree 620 of FIG. 6A, which includes a brightened area 656A-656F that matches the selected area of interest 622. Conversely, the remaining area of each the similar portions 654A-654F is de-emphasized by fading it out. Six results are included in the query results 652 as specified in the results quantity textbox 606 of FIG. 6A. The brightened areas 656A-656F each have an overall consumption that is similar to the selected area of interest 622 and can be easily distinguished from the remaining areas that are faded out.

FIGS. 7A-7B are color diagrams of example pixel calendar trees of power consumption data that show visual correlation relationships. In FIG. 7A, pixel calendar tree display 700 includes a pixel calendar tree 720 that presents consumption data for the building. Pixel calendar tree display 700 also includes user interface elements 702 for specifying visual search query parameters. Specifically, user interface elements 702 include a search type drop down 704 for specifying whether the visual relation query should be a visual similarity query or a visual correlation query, a results quantity textbox 706 for specifying the number of results that should be returned from the query, and a process query button 708 for submitting the request for the query. In this example, the search type drop down 704 shows that a visual correlation query is selected.

Pixel calendar tree display 700 also includes a histogram 710 showing statistics for the currently selected area of interest 722. The user may specify the selected area of interest 722 by, for example, dragging a selection box over the desired portion of the pixel calendar tree 720.

FIG. 7B shows the results of a visual relation query as rendered in a unified display 750. A portion 740 of the pixel calendar tree 720 of FIG. 7A is displayed to show the selected area of interest 722. In this example, the histogram 710 showing statistics for the selected area of interest is rendered just below the pixel calendar tree 720 in the unified display 710. The unified display 750 also includes query results 752, which in turn includes correlated portions 754A-754F of the pixel calendar tree 720 of FIG. 7A. Each of the correlated portions 754A-754F displays a subset of the pixel calendar tree 720 of FIG. 7A, which includes a brightened area 756A-756F that matches the selected area of interest 722. Conversely, the remaining area of each of the correlated portions 754A-754F is de-emphasized by fading it out. Six results are included in the query results 752 as specified in the results quantity textbox 706 of FIG. 7A. The brightened portions 756A-756F each show a usage pattern for power consumption that is similar to the selected area of interest 722 and can be easily distinguished from the remaining areas that are faded out.

The foregoing disclosure describes a number of example embodiments for providing visual analytics of temporal-spatial relationships using a pixel calendar tree. In this manner, the embodiments disclosed herein enable matching portions from multiple sensors to be simultaneously displayed with an area of interest that is selected from a pixel calendar tree.

We claim:

1. A system for providing visual analytics of temporal-spatial relationships using a pixel calendar tree, the system comprising:
a plurality of power meter nodes each positioned to obtain power consumption data for one of a plurality of regions within a building, wherein the power consumption data is divided into data segments that are collected at regular time intervals;
a processor operatively connected to the plurality of power meter nodes, the processor to:
recursively process the power consumption data to generate a pixel calendar tree by:
using a power meter hierarchy to subdivide the pixel calendar tree into a plurality of tree portions according to a proportion of the power consumption data attributed to each of the plurality of power meter nodes, wherein the plurality of power meter nodes are hierarchically arranged in the power meter hierarchy according to a physical infrastructure of the building, and wherein the plurality of tree portions are arranged in the pixel calendar tree according to an importance of the proportion of the power consumption data;
generating a plurality of pixel cells in the pixel calendar tree, wherein each of the plurality of pixel cells represents a day in the power consumption data; and
generating a plurality of cell borders that each surround one of the plurality of pixel cells, wherein each of the plurality of cell borders are rendered as empty pixels between the plurality of pixel cells; and
generate a pixel calendar display comprising the plurality of pixel cells and the plurality of cell borders.

2. The system of claim 1, wherein the processor is further to:
receive a selection of an interested area in the pixel calendar tree, the interested area including a subset of the power consumption data that is associated with a selected period of time;
use a visual relation query to identify a plurality of matching portions in the pixel calendar tree each including a matching area that matches the interested area; and
generate a unified display comprising the plurality of matching portions, wherein the matching area of each of the plurality of matching portions is brightened.

3. The system of claim 2, wherein the visual relation query is a Euclidian similarity query that identifies each of the plurality of matching portions as having an overall consumption amount that is similar to the subset of power consumption during the selected period of time.

4. The system of claim 2, wherein the visual relation query is a Pearson correlation query that identifies each of the plurality of matching portions as having a similar usage pattern as the subset of power consumption during the selected period of time.

5. The system of claim 2, wherein a remaining area of each of the plurality of matching portions is faded.

6. The system of claim 1, wherein the plurality of cell borders are generated based on a total consumption of the power consumption that is attributable to each of the power meter nodes, wherein the total consumption of a power meter node is used to determine a width and a height of the empty pixels in the plurality of cell borders that are associated with the power meter node.

7. A method for providing visual analytics of temporal-spatial relationships using a pixel calendar tree, the method comprising:
obtaining power consumption data for a plurality of regions within a budding from a plurality of power meter nodes, wherein the power consumption data is divided into data segments that are collected at regular time intervals;
receiving a selection of an interested area in the pixel calendar tree, the interested area including a subset of the power consumption data that is associated with a selected period of time;
using a visual relation query to identify a plurality of matching portions in the pixel calendar tree each including a matching area that matches the interested area; and
generating a unified display comprising the plurality of matching portions, wherein the matching area of each of the plurality of matching portions is brightened.

8. The method of claim 7, further comprising:
recursively processing the power consumption data to generate a pixel calendar tree by:
using a power meter hierarchy to subdivide the pixel calendar tree into a plurality of tree portions according to a proportion of the power consumption data attributed to each of the plurality of power meter nodes, wherein the plurality of power meter nodes are hierarchically arranged in the power meter hierarchy according to a physical infrastructure of the building, and wherein the plurality of tree portions are arranged in the pixel calendar tree according to an importance of the proportion of the power consumption data;
generating a plurality of pixel cells in the pixel calendar tree, wherein each of the plurality of pixel cells represents a day in the power consumption data; and
generating a plurality of cell borders that each surround one of the plurality of pixel cells, wherein each of the plurality of cell borders are rendered as empty pixels between the plurality of pixel cells; and
generating a pixel calendar display comprising the plurality of pixel cells and the plurality of cell borders.

9. The method of claim 8, wherein the plurality of cell borders are generated based on a total consumption of the power consumption that is attributable to each of the power meter nodes, wherein the total consumption of a power meter node is used to determine a width and a height of the empty pixels in the plurality of cell borders that are associated with the power meter node.

10. The method of claim 7, wherein the visual relation query is a Euclidian similarity query that identifies each of the plurality of matching portions as having an overall consumption amount that is similar to the subset of power consumption during the selected period of time.

11. The method of claim 7, wherein the visual relation query is a Pearson correlation query that identifies each of the plurality of matching portions as having a similar usage pattern as the subset of power consumption during the selected period of time.

12. The method of claim 7, wherein a remaining area of each of the plurality of matching portions is faded.

13. A non-transitory machine-readable storage medium encoded with instructions executable by a processor for providing visual analytics of temporal-spatial relationships using a pixel calendar tree, the machine-readable storage medium comprising instruction to:
obtain power consumption data for a plurality of regions within a building from a plurality of power meter nodes, wherein the power consumption data is divided into data segments that are collected at regular time intervals;
recursively process the power consumption data to generate a pixel calendar tree by:
using a power meter hierarchy to subdivide the pixel calendar tree into a plurality of tree portions according to a proportion of the power consumption data attributed to each of the plurality of power meter nodes, wherein the plurality of power meter nodes are hierarchically arranged in the power meter hierarchy according to a physical infrastructure of the building, and wherein the plurality of tree portions are arranged in the pixel calendar tree according to an importance of the proportion of the power consumption data;
generating a plurality of pixel cells in the pixel calendar tree, wherein each of the plurality of pixel cells represents a day in the power consumption data; and
generating a plurality of cell borders that each surround one of the plurality of pixel cells, wherein each of the plurality of cell borders are rendered as empty pixels between the plurality of pixel cells;
generate a pixel calendar display comprising the plurality of pixel cells and the plurality of cell borders; and
receive a selection of an interested area in the pixel calendar display, the interested area including a subset of the power consumption data that is associated with a selected period of time.

14. The storage medium of claim 13, further comprising instruction to:
use a visual relation query to identify a plurality of matching portions in the pixel calendar tree each including a matching area that matches the interested area; and
generate a unified display comprising the plurality of matching portions, wherein the matching area of each of the plurality of matching portions is brightened.

15. The storage medium of claim 13, wherein the plurality of cell borders are generated based on a total consumption of the power consumption that is attributable to each of the power meter nodes, wherein the total consumption of a power meter node is used to determine a width and a height of the empty pixels in the plurality of cell borders that are associated with the power meter node.
